(19) United States
(12) Patent Application Publication
(10) Pub. No.: US 2008/0105376 A1
(43) Pub. Date: May 8, 2008

(54) SYSTEM AND METHOD FOR THE REMOVAL OF A LABEL FROM AN OBJECT

(75) Inventors: Alain Pare, Kirkland (CA); Thomas D. Haubert, Columbus, OH (US); Stephen C. Schmitt, Dublin, OH (US); John P. Tallarico, Powell, OH (US)

Correspondence Address: MYERS BIGEL SIBLEY & SAJOVEC, PO BOX 37428, RALEIGH, NC, 27627, US

(73) Assignee: TECHNOLOGIES HUMANWARE CANADA INC.

(21) Appl. No.: 11/857,589

(22) Filed: Sep. 19, 2007

Related U.S. Application Data
(60) Provisional application No. 60/845,756, filed on Sep. 20, 2006.

(51) Int. Cl. B32B 38/10; G11B 3/70

(52) U.S. Cl. 156/344; 156/584; 369/277

(57) ABSTRACT

A method and a system for removing a label from an object are provided. The object has a groove or grooves therein to receive teeth of a fork-like tool. The teeth are inserted in the grooves, under the label, and are used to lift an end portion of the label. This end portion is then grabbed and pulled on to remove the remainder of the label from the object. The method and system can advantageously be used on a cartridge for an audio book for print-disabled users.

### CROSS-REFERENCE TO RELATED APPLICATIONS

This application claims priority to U.S. Provisional Application Ser. No. 60/845,756, filed Sep. 20, 2006, the disclosure of which is incorporated by reference in its entirety.

### RIGHTS IN THE INVENTION

This invention was made, in part, with funding from the United States Government under Award No. GS-23F-0011L and, accordingly, the United States Government may have certain rights in this invention.

### FIELD OF THE INVENTION

The present invention relates to the field of object labelling and more particularly concerns facilitating the removal of labels from objects such as cartridges.

### BACKGROUND OF THE INVENTION

Labels made of paper, plastic or the like are regularly affixed to objects in order to provide information thereon. Labels can however be burdensome to remove depending on various factors such as the shape of the object, the surface the label is in contact with, the material of the label, the type of adhesive used between the label and the object, etc.

In some cases, easy removal of a label may be particularly desirable, for example if the object includes contents which can be changed. A non-limitative example of such an object described herein is the case of an audio book for print-disabled users.

“Audio” or “talking” books are an important alternative format to print for providing access to books of all types for print-disabled persons who cannot read conventional print books due to a visual, physical or learning disability. The contents of a print document, in its entirety or abridge, is usually read by a professional or a volunteer and recorded on a medium appropriate for distribution, such as a tape cassette or a CD. With recent improvements in digital memory devices, the audio book industry now uses low cost digital media such as Flash memory devices for storing their products. As digital storage devices often have a size and shape making difficult their manipulation by print-disabled users, it has been found preferable to enclose such devices within cartridges sized and shaped so that their manipulation by visually impaired, physically disabled and learning disabled users is facilitated.

An example of such a cartridge is shown in provisional patent application No. 60/845,763, filed on Sep. 20^{th}, 2006 and entitled “DIGITAL AUDIO BOOK CARTRIDGE AND PLAYER WITH MANIPULATION-FACILITATING FEATURES”, the content of which is incorporated herein by reference. The disclosed cartridge is preferably provided with a label identifying the contents of the audio book, both in visible printed and in Braille markings. In order to prevent damage to the Braille markings when handling or stacking the cartridge, its top surface is provided with a ridge surrounding the label. However, this ridge has the drawback of making it difficult to access and remove the label to replace it when the cartridge content is changed. The facilitation and possible automation of this process is desirable as digital storage media can easily be re-used and it would be both economical and environmentally-friendly to re-use the cartridge packages as well.

There is therefore a need for a method and a system making it possible to easily remove the label on an object, such as for example a digital audio book cartridge.

### SUMMARY OF THE INVENTION

In accordance with a first aspect of the present invention, there is provided a method for removing a label affixed on a label-receiving area on a surface of an object. The object has at least one groove provided in this surface and projecting from an edge of the object at least partially across the label receiving area. The method includes the steps of:
a) providing a fork-like tool having at least one tooth matching the at least one groove. The at least one tooth is sized and spaced apart to fit in the at least one groove;
b) inserting the at least one tooth of the fork-like tool in the corresponding at least one groove;
c) lifting the fork-like tool generally transversally to the surface of the object, therefore peeling off an end portion of the label;
d) grabbing the end portion of the label; and
e) pulling on the end portion of the label to remove a remainder of the label from the object.

In accordance with another aspect of the invention, there is also provided a system for removing a label affixed on a label-receiving area on a surface of an object. The object has at least one groove provided in this surface and projecting from an edge of the object at least partially across the label receiving area. The system includes:
a) immobilizing means for immobilizing the object;
b) a fork-like tool having at least one tooth matching the at least one groove, the at least one tooth being sized and spaced apart to fit in the at least one groove;
c) a clamping member adapted to clamp an end of the label;
d) a mobile arm movable with respect to the immobilizing means, the fork-like tool and clamping member being mounted thereon; and
e) a controller for sending a sequence of control signals to the mobile arm, the sequence of control signals successively causing an inserting of the at least one tooth of the fork-like tool in the corresponding at least one groove of the object, a lifting of the fork-like tool generally transversally to the surface of the object, therefore peeling off an end portion of the label, a clamping of the end portion of the label with the clamping member, and a moving of the clamping member in order to pull on the end portion of the label, to remove a remainder of the label from the object.

In accordance with yet another aspect of the present invention there is further provided a cartridge for providing digital audio content to print-disabled users. The cartridge first includes a digital storing medium for storing the digital audio content thereon. The cartridge further includes casing encasing the digital storing medium. The casing has a top surface defining a label-receiving area adapted to receive a label associated with the audio book content, at least one groove being provided in the top surface of the casing. The at least one groove projects from an edge of the casing at least partially across the label receiving area. The casing further includes a ridge provided on the top surface of the cartridge and surrounding the label-receiving area, the ridge being provided with at least one indentation therein. Each of the at least one indentation is disposed in alignment with a corresponding one of the at least one groove.

Other features and advantages of the invention will be better understood upon reading of preferred embodiments thereof with reference to the appended drawings.

### BRIEF DESCRIPTION OF THE DRAWINGS

FIG. 1 schematically illustrates a process for re-using audio book cartridges.

FIG. 2A is a top perspective view of a cartridge provided with a label according to an embodiment of the invention. FIGS. 2B, 2C and 2D are respectively perspective top and front views of the cartridge of FIG. 2A without the label.

FIG. 3 is a perspective view of a fork-like tool for use in removing a label according to one embodiment of the invention.

FIGS. 4A to 4G are conceptual diagrams illustrating steps of a method for removing a label from an audio book cartridge according to another embodiment of the invention

FIGS. 5A and 5B are perspective views of a system for removing a label from a cartridge in use, respectively showing two different stages of the removal of the label.

### DESCRIPTION OF PREFERRED EMBODIMENTS OF THE INVENTION

As mentioned above, the present application concerns the removal of a label from an object. It is considered with the scope of the present invention to apply the label removing method and system of the invention to remove a label from any appropriate object such as a package, casing, etc. In the description below, the invention will be described as applied to a cartridge for a print-disabled user, but one skilled in the art will understand the this particular embodiment is given solely by way of example and is not limitative to the scope of the invention.

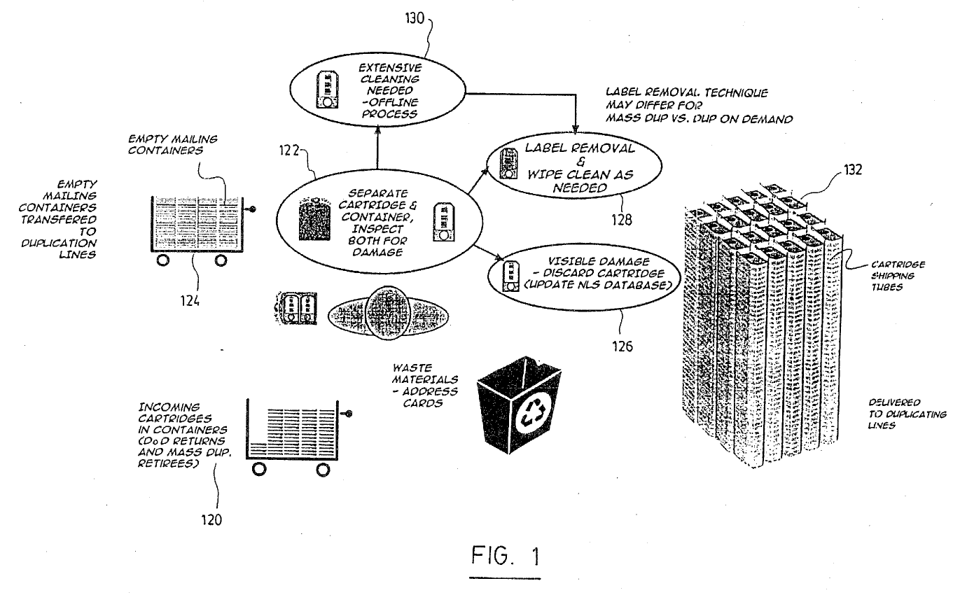

With reference to FIG. 1, there is shown an example of a process for re-using audio book cartridges. It will be understood that this process is given by way of example to illustrate the context of the present invention and that it is in no way considered limitative thereto.

Incoming cartridges are received 120 at an appropriate facility in containers, for mass processing. The cartridges each include an audio content which is not desired any longer. This may for example be the case of less popular books, retired popular books, outdated content, older issues of magazines, etc. The cartridges may be shipped in a container including one or more cartridges, and are therefore separated 122 from these containers when they are received at the facility. The shipping container may be either discarded if damaged or re-used 124 if possible. The cartridges are inspected 122 for visible damages, and damaged units are discarded 126. An optional offline extensive cleaning process 130 may be provided for units whose condition requires it. Units in good condition have their label removed 128 according to the present invention, and may be wiped clean if needed afterwards. They are then shipped out 132 of the facility in shipping tubes to be delivered to duplicating lines where they will be provided with new contents and accompanying labels.

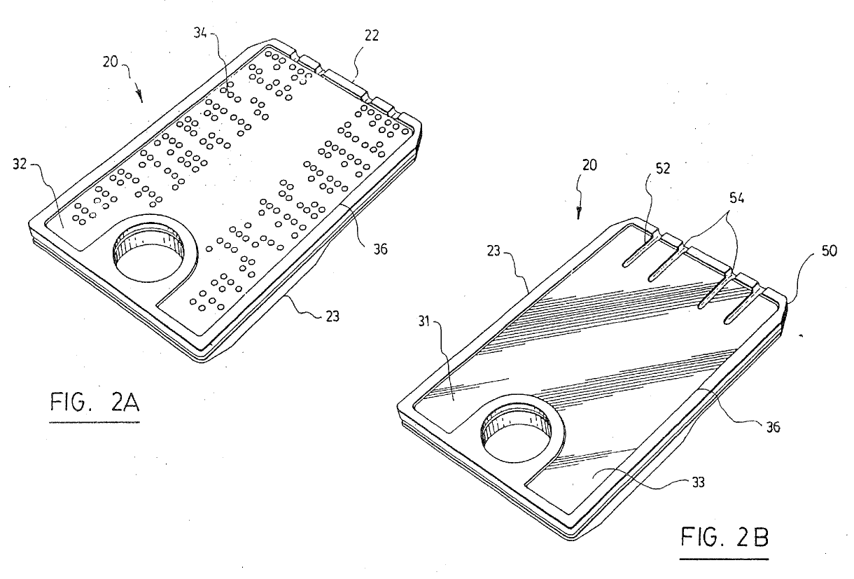

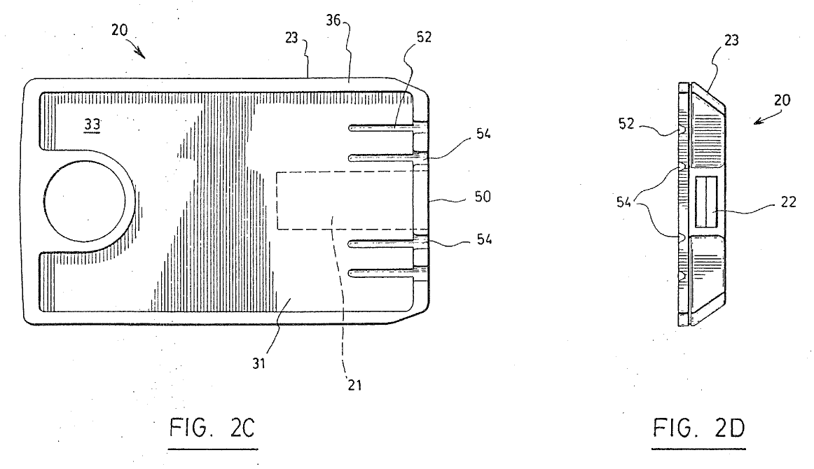

Referring to FIGS. 2A to 2D, there is illustrated cartridge 20 for print-disabled users according to one aspect of the invention.

The expression “print-disabled users” is used herein to designate users which may have some difficulty in using traditional print material. This group includes blind or low vision users, users with cognitive difficulties, users with a physical disability preventing or impairing the use of their hands, users with arthritis, elderly users, users with cerebral palsy, users with multiple sclerosis, etc. It will be understood by one skilled in the art that this list is non-exhaustive and that a given print-disabled user may be affected by one or a combination of the disadvantages listed above or others.

The cartridge 20 includes a digital storage medium 21 such as an off-the-shelf memory card or the like. The digital storage medium 21 is preferably a random access media such as such as a flash memory chip, hard drive, etc. On this digital storage medium 21 is stored digital audio content which may be of interest to a print disabled user, this content being also referred to herein as an “audio book”. It is understood that the expression “audio book” is used herein to refer to any voice or audio recording appropriate for distribution through this type of medium. For example, and not exhaustively, the recorded information may be a literary work, reference work, school book, children's book, non-fiction book, compilation, newspaper or magazine articles, or even music, radio recording, video, text, maps, biometric data, or other types of recorded audio material. The recording may have been created by any appropriate technique known in the art, such as for example recording an audio file using a Text-To-Speech (TTS) input.

The digital storing medium is packaged in a casing 23. In the illustrated embodiment, the casing 23 is provided with several features facilitating its handling by visually impaired, physically disabled, learning disabled users or the like, as described in more detail in the above-mentioned provisional patent application No. 60/845,763, entitled “DIGITAL AUDIO BOOK CARTRIDGE AND PLAYER WITH MANIPULATION-FACILITATING FEATURES”. A connector, for example a standard USB male connector 22, is preferably accessible from the front side of the casing 23 for allowing the digital audio content to be accessed by an appropriate player (not shown). The connector may alternatively be positioned at another location of the cartridge and other types of connectors or different manners of accessing the information stored in the cartridge may also be considered as part of the present invention.

The casing 23 has a top surface 31 which defines a label receiving area 33. Alternatively, the label receiving area could be positioned on a surface other than the top surface such as for example on the bottom or on a side of the cartridge. In the illustrated embodiment, the label receiving area 33 occupies substantially the entire top surface 31, but it will be understood that in other embodiments it could encompass only a portion of this surface. The label-receiving area may have any appropriate shape, and preferably follows the shape of the top surface 31 of the casing 23.

The label-receiving area 33 is adapted to receive a label 32 (see FIG. 2A) associated with the digital audio content stored in the digital storage device 21. The label includes Braille markings 34, and may optionally also bear visible printed markings (not shown) which may or may not match the information provided in Braille. The label 32 preferably includes any information relevant to the identification of the content of the digital audio content, such as a book title, author, year of publication, length of the recording, etc. It may also include information about the cartridge itself, such as its memory capacity and a lot number, serial number, barcode, etc., or any other relevant information which can be legal, promotional, corporate or otherwise. Alternatively, information which does not change with the content of the cartridge may be provided separately, either directly on the casing or through a different label.

The label 32 is preferably designed so that it is easy to apply and remove manually or using automated equipment, but is not subject to accidental loosening during handling. It is preferably rigid enough to avoid tearing during removal. The label is preferably made of paper, plasticized paper, plastic or any other suitable material. The label is provided on its back surface with an adhesive which is preferably of a removable type or could alternatively be permanent. In the case of permanent labels, pre-heating before removal may be necessary.

As can be particularly seen in FIGS. 2B and 2C, the top surface 31 of the casing 23 is provided with a plurality of shallow parallel grooves 52 therein, extending from an edge of the casing 23 inwards partially across the label-receiving area 33. The expression “groove” is understood herein to refer to a line formed within the top surface 31 of the casing 23. The grooves have a generally elongated shape and have a width adapted to receive an appropriate tool therein as will be explained further below. Preferably, the grooves are of a generally shallow depth. In the illustrated embodiment the grooves extend from the front edge 50 of the casing 23 which may be advantageous in that the front end is less handled by users than the rear end, and the grooves 52 are protected from spills or other damaging events when the cartridge 20 is inserted in a player. Alternatively, the grooves 52 may however extend from another edge of the cartridge without departing from the scope of the present invention. The grooves 52 are preferably moulded directly as part of the casing 23, or could be machined subsequently.

Although the accompanying drawings show a total of four grooves 52 positioned in pair on either sides of the casing 23, it will be understood that it is within the scope of the present invention to provide any appropriate number of such grooves, distributed in any appropriate manner over the top surface 31. Although the grooves will be referred to in the plural in the description below, it will be understood that a single groove could be sufficient for the purpose of the present invention. The grooves 52 may have any appropriate length and may extend across the label-receiving area 33 more or less than shown in the accompanying drawings.

The top surface 31 of the casing 23 is further provided with a ridge 36 surrounding the label-receiving area 33. In the preferred embodiment, the ridge 36 follows the top edge of the casing 23, but other configurations could alternatively be considered. The ridge 36 is preferably integral to the cartridge and moulded therewith. Advantageously, the provision of the ridge 36 prevents the raised Braille markings 34 from being damaged or erased when cartridges 20 are stacked and/or rubbed against each other.

The ridge 36 is provided with a number of indentations 54 therein matching the number of grooves 52 in the top surface 31 of the casing 23. Each indentation 54 is in alignment with a corresponding groove 52. By “indentation”, it is meant a notch or an empty space of any appropriate shape interrupting the ridge and allowing access to the corresponding groove as explained further below. As for the grooves, the indentations 54 are preferably moulded directly as part of the ridge 36 or could be machined subsequently. The indentations 54 further preferably have a rounded shape to reduce the potential accumulation of contaminants observed when sharp edges are present.

The provision of grooves 52 in the top surface of the casing 23 and matching indentations 54 in the ridge 36 is particularly useful to facilitate the removal of the label 32 from the cartridge 20. As content stored on digital storage media can easily be erased and replaced, the main difficulty in cartridge recycling is the replacement of the label 32. This issue can be addressed with the above described cartridge 20, and with a method and a system for removing the label 32 from this cartridge 20 as described below.

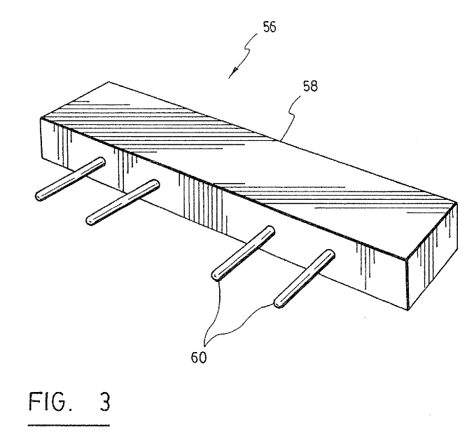

Referring to FIG. 3, there is shown a fork-like tool 56 which is particularly adapted for removing a label from a cartridge as described above. It will be understood that the tool of FIG. 3 could be used to remove a label from any appropriate object other than a cartridge. The fork-like tool 56 has a handle member 58 from which projects a plurality of parallel teeth 60. The teeth 60 are sized and spaced apart in order to be received in the grooves of the cartridge, and in the illustrated embodiment, four teeth 60 are therefore shown to be received in the four grooves of the cartridge of FIGS. 2A to 2D. The teeth 60 preferably each have a rounded extremity opposite the handle member 58. It will be readily understood that the handle member 58 can take a variety of different shapes than the one shown in FIG. 3.

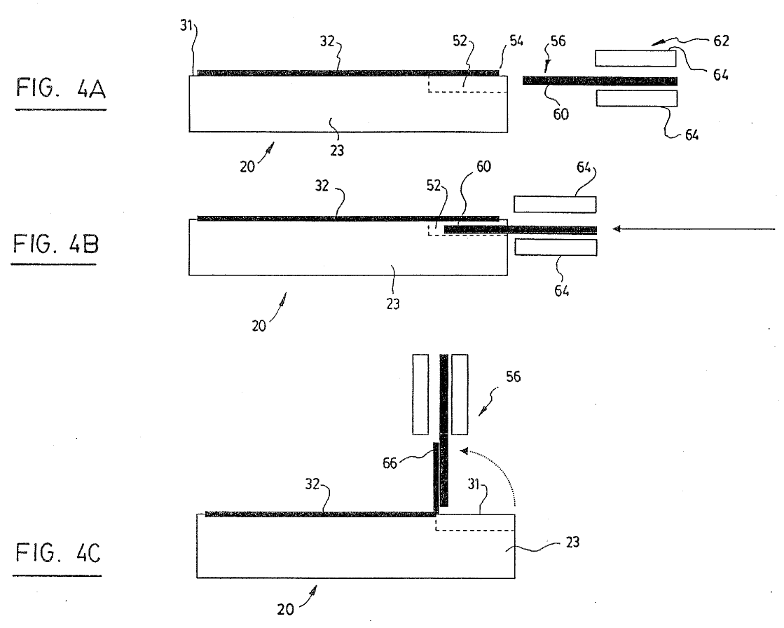

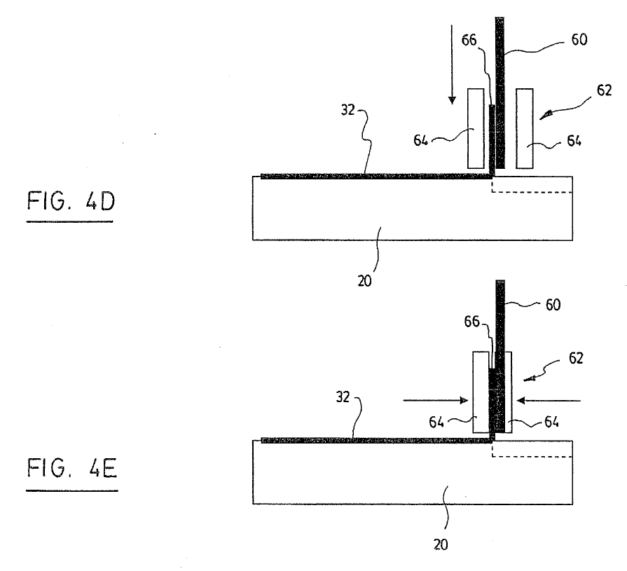

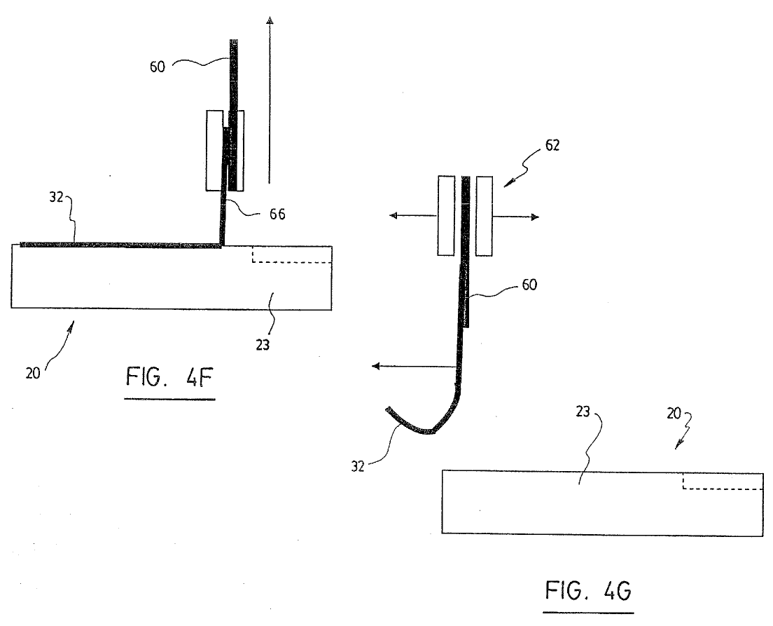

With reference to FIGS. 4A to 4G a method for removing a label affixed on the label-receiving area of an object is illustrated, applied by way of example to a cartridge as shown in FIGS. 2A to 2D.

The method first includes providing a fork-like tool 56 having a tooth or teeth 60 matching the groove or grooves 52 in the top surface 31 of the casing 23. As mentioned above, the teeth 60 are sized and spaced to fit in the grooves 52. The method can be carried out manually, in which case the fork-like tool 56 preferably includes a handle member 58 as for example shown in FIG. 3, or by an automated system, of which the fork-like tool 56 is an integrated component.

The method further includes a step of inserting the teeth 60 of the fork-like tool 56 in the corresponding grooves 52 of the cartridge 20, In the case of a cartridge as illustrated, the teeth 60 are inserted through the indentations in the ridge (not shown) in order to reach the grooves 52. This is preferably achieved by positioning the teeth 60 in horizontal alignment with the corresponding grooves 52 (see FIG. 4A), that is, along the same plane as the top surface 31 of the casing 23, and sliding the teeth 60 in the grooves 52 from the edge of the cartridge (see FIG. 4B).

Referring to FIG. 4C, the method then includes the step of lifting the fork-like tool 56 generally transversally to the top surface 31 of the casing 23, therefore peeling off and lifting the front end portion 66 of the label 32 which is over the teeth 60. This is preferably accomplished by rotating the fork-like tool 56 about the end of the teeth 60 which is inserted in the grooves 52, as FIG. 4C illustrates.

Referring to FIGS. 4D and 4E, the lifted end portion 66 of the label 32 is then grabbed. Preferably, a clamping member 62 having a pair of clamping plates 64 extending in parallel on either side of the teeth 60 is provided for this purpose. During the insertion of the teeth 60 into the grooves 52 and their lifting from the casing (see FIGS. 4B and 4C), the clamping plates 64 are preferably in a retracted position at the rear end of the teeth and slightly spaced apart from each other. To grab the end portion of the label, the clamping plates 64 are preferably moved forward until they are in a position to grab the front portion 66 of the label 32 (FIG. 4D), and then closed one against the other (FIG. 4E). If the method is performed manually, the grabbing of the front end of the label could in this case be performed using any appropriate implement such as pliers, tweezers, or even one's fingers.

Referring to FIGS. 4F and 4G, the method then includes the step of pulling on the end portion 66 of the label 32 to remove the remainder of the label 32 from the cartridge 20 In the illustrated embodiment, this is achieved by lifting the clamping member 62 holding the end portion 66 of the label 32 away from the cartridge 20. As shown in FIG. 4G, once the label 32 has been completely removed from the cartridge, the clamping member 62 can be opened and retracted back to its original position, and the label 32 removed from the teeth 60 and discarded.

Optionally, the top surface of the casing may be wiped clean with a solvent such as isopropyl alcohol to remove any residue remaining thereon.

The method above may further include a step of pre-heating the label prior to removal. This may be advantageous depending on the type of cartridge, label and adhesive used. Temperatures of a range between 55° C. and 65° C. have been found adequate in preliminary tests.

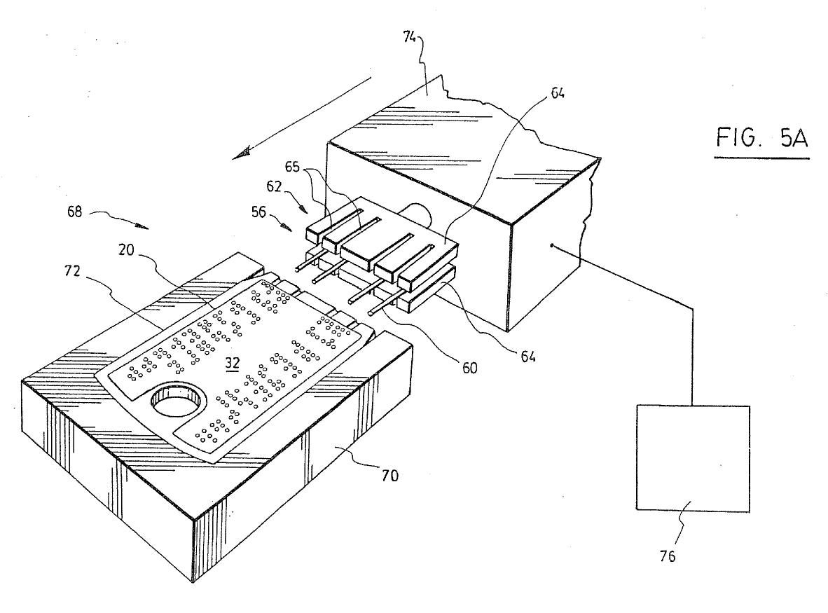

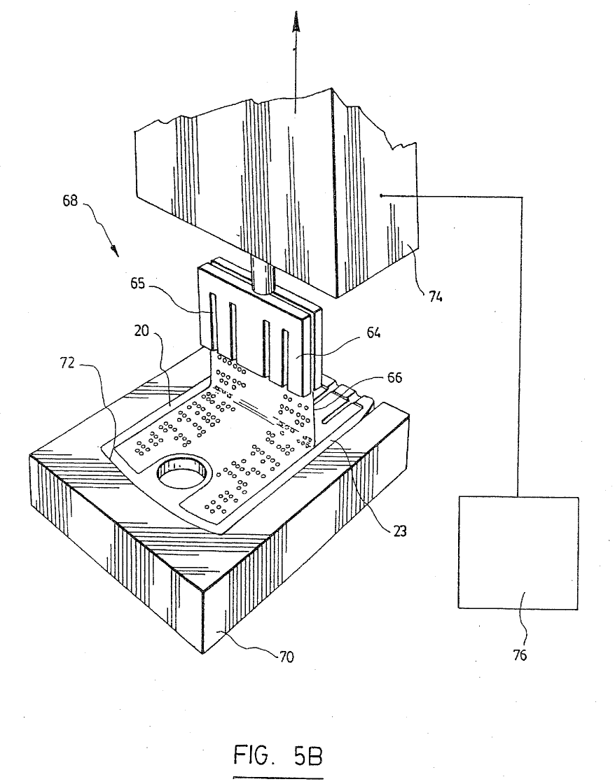

Referring to FIGS. 5A and 5B, there is shown a system 68 for removing a label 32 affixed on the label-receiving area of a cartridge 20 as described above, according to an embodiment of the present invention.

The system 68 includes immobilizing means for immobilizing the cartridge 20. Any appropriate mechanism may be provided for this purpose by supporting, holding, retaining, or abutting the cartridge so that it does not slide or move during the label-removal process. In the illustrated embodiment, a holder 70 having a recess 72 closely fitting the shape of the casing of the cartridge 20 is shown by way of example. Of course, the immobilizing means can differ depending on the shape and nature of the object from which a label is removed.

The system 68 further includes a fork-like tool 56 having teeth 60 matching the grooves of the cartridge, the teeth being sized and spaced apart to fit in these grooves. A clamping member 62 adapted to clamp an end of the label is also provided. The clamping member 62 preferably has a pair of clamping plates 64 extending in parallel on either side of the teeth 60. As best seen in FIG. 5A, the clamping plates 64 preferably have channels 65 therein for receiving the teeth 60, that is, spaces in one or both clamping plates 64 in which the teeth 60 can fit. The channels 65 advantageously house the teeth 60 when the clamping plates 64 are closed one against the other to grab the end portion 66 of the label 32.

The fork-like tool 56 and clamping member 62 are mounted on a mobile arm 74 movable with respect to the holder 70.

A controller 76 is provided for sending a sequence of control signals to the mobile arm 74 mounting the fork-like tool 56 and clamping member 62, the sequence of control signals initiating the steps of the method described above. The control signals therefore successively cause the inserting of the teeth 60 of the fork-like tool 56 in the corresponding grooves of the cartridge 20 through the corresponding indentations in the ridge, the lifting of the fork-like tool 56 generally transversally to the top surface 31 of the cartridge 20, therefore peeling off an end portion 66 of the label 32, the clamping of the end portion 66 of the label 32 with the clamping member 62, and the moving of the clamping member 62 in order to pull on the end portion 66 of the label 32, to remove the remainder of the label 32 from the cartridge 20. The controller 76 may be embodied by a computer system or any other appropriate device. Alternatively, the controller may be embodied by a human operator operating the system through a control interface.

It is to be noted that an automated system for carrying out the method above may include any appropriate component additional to those discussed above.

Of course, numerous modifications could be made to the embodiments described above without departing from the scope of the present invention.

1. A method for removing a label affixed on a label-receiving area on a surface of an object, said object having at least one groove provided in said surface and projecting from an edge of the object at least partially across the label receiving area, the method comprising the steps of:
a) providing a fork-like tool having at least one tooth matching the at least one groove, said at least one tooth being sized and spaced apart to fit in said at least one groove;
b) inserting the at least one tooth of the fork-like tool in the corresponding at least one groove;
c) lifting the fork-like tool generally transversally to the surface of the object, therefore peeling off an end portion of the label;
d) grabbing said end portion of the label; and
e) pulling on said end portion of the label to remove a remainder of the label from the object.

2. The method according to claim 1, comprising an additional step prior to step b) of heating the label.

3. The method according to claim 1, wherein the inserting of step b) comprises positioning the at least one tooth of the fork-like tool along a plane of the surface of the object and in alignment with the corresponding at least one groove, and sliding the at least one tooth in the at least one groove from the edge of the object.

4. The method according to claim 1, wherein the lifting of step c) comprises rotating the fork-like tool about an end of the at least one tooth inserted in the at least one groove.

5. The method according to claim 1, comprising an additional step f) of cleaning the top surface with a solvent.

6. The method according to claim 1, wherein steps b) through d) are automated.

7. The method according to claim 1, wherein steps b) through d) are performed manually.

8. The method according to claim 1, wherein said object is a cartridge having a ridge provided on the surface thereof and surrounding the label-receiving area, said ridge being provided with at least one indentation therein, each of said at least one indentation being disposed in alignment with a corresponding one of the at least one groove, step b) of the method comprising inserting the at least one tooth of the fork-like tool through the corresponding at least one indentation.

9. A system for removing a label affixed on a label-receiving area on a surface of an object, said object having at least one groove provided in said surface and projecting from an edge of the object at least partially across the label receiving area, comprising:
a) immobilizing means for immobilizing the object;
b) a fork-like tool having at least one tooth matching the at least one groove, said at least one tooth being sized and spaced apart to fit in said at least one groove;
c) a clamping member adapted to clamp an end of the label;
d) a mobile arm movable with respect to the immobilizing means, the fork-like tool and clamping member being mounted thereon;
e) a controller for sending a sequence of control signals to the mobile arm, the sequence of control signals successively causing an inserting of the at least one tooth of the fork-like tool in the corresponding at least one groove of the object, a lifting of the fork-like tool generally transversally to the surface of the object, therefore peeling off an end portion of the label, a clamping of the end portion of the label with the clamping member, and a moving of the clamping member in order to pull on the end portion of the label, to remove a remainder of the label from the object.

10. The system according to claim 9, further comprising a heater for heating the label prior to its removal.

11. The system according to claim 9, wherein the immobilizing means comprise a holder having a recess therein closely fitting a shape of the object.

12. The system according to claim 9, wherein the clamping member comprises a pair of clamping plates extending in parallel on either side of the teeth, said clamping plates being movable between a retracted position rearward of the teeth and slightly spaced apart from each other, and a grabbing position aligned with the teeth and closed one against the other.

13. The system according to claim 12, wherein at least one of the clamping plates comprises channels therein adapted to receive the teeth when the clamping plates are in the grabbing position.

14. The combination of the system according to claim 9 with said object, wherein said object is a cartridge having a ridge provided on the surface thereof and surrounding the label-receiving area, said ridge being provided with at least one indentation therein, each of said at least one indentation being disposed in alignment with a corresponding one of the at least one groove.

15. A cartridge for providing digital audio content to print-disabled users, comprising:
a digital storing medium for storing said digital audio content thereon; and
a casing encasing said digital storing medium, comprising:
a surface defining a label-receiving area adapted to receive a label associated with said audio book content;
at least one groove provided in the surface of the casing, said at least one groove projecting from an edge of the casing at least partially across the label receiving area; and
a ridge provided on the top surface of the cartridge and surrounding the label-receiving area, said ridge being provided with at least one indentation therein, each of said at least one indentation being disposed in alignment with a corresponding one of the at least one groove.

16. The cartridge according to claim 15, wherein said at least one groove comprises a plurality of grooves extending in parallel, and the at least one indentation comprises a corresponding plurality of indentations.

17. The cartridge according to claim 15, wherein each of said at least one indentation has a rounded shape.

18. The combination of the cartridge according to claim 15 and the label associated with said audio book content said label being provided with Braille markings.

19. The combination of claim 18, wherein said label is further provided with printed markings.
